(19) United States
(12) Patent Application Publication
(10) Pub. No.: US 2016/0088184 A1
(43) Pub. Date: Mar. 24, 2016

(54) IMAGE FORMING APPARATUS, PROCESSING METHOD, AND NON-TRANSITORY COMPUTER READABLE MEDIUM

(71) Applicant: FUJI XEROX CO., LTD., Tokyo (JP)

(72) Inventor: Tomoka NAKAGAWA, Kanagawa (JP)

(73) Assignee: FUJI XEROX CO., LTD., Tokyo (JP)

(21) Appl. No.: 14/607,703

(22) Filed: Jan. 28, 2015

(30) Foreign Application Priority Data
Sep. 24, 2014 (JP) 2014-193517

(51) Int. Cl. H04N 1/327; H04N 1/32

(52) U.S. Cl. CPC H04N 1/32765; H04N 1/32747; H04N 1/32566; H04N 1/32614; H04N 2201/0094

(57) ABSTRACT

An image forming apparatus includes plural communication interfaces, a network service executing unit, a type-of-network determining unit, and a communication interface selecting unit. The network service executing unit executes at least one network service. The type-of-network determining unit determines types of communication networks respectively connected to the plural communication interfaces. The communication interface selecting unit selects, in accordance with a type of a communication network used in the at least one network service, a communication interface to be used in the at least one network service from among the plural communication interfaces.

### CROSS-REFERENCE TO RELATED APPLICATIONS

This application is based on and claims priority under 35 USC 119 from Japanese Patent Application No. 2014-193517 filed Sep. 24, 2014.

### BACKGROUND

1. Technical Field

The present invention relates to an image forming apparatus, a processing method, and a non-transitory computer readable medium.

2. Related Art

An information processing apparatus may include plural communication interfaces and may be used such that the plural communication interfaces are connected to plural communication networks different from one another. For example, Windows (registered trademark) loaded in an information processing apparatus has a single routing table, which is information about communication paths including plural communication interfaces, and selects, from among the communication paths indicated in the routing table, a communication path which includes a small number of routers or a communication path which enables high speed and high reliability. That is, a communication interface that is most suitable for a communication partner is selected.

### SUMMARY

According to an aspect of the invention, there is provided an image forming apparatus including plural communication interfaces, a network service executing unit, a type-of-network determining unit, and a communication interface selecting unit. The network service executing unit executes at least one network service. The type-of-network determining unit determines types of communication networks respectively connected to the plural communication interfaces. The communication interface selecting unit selects, in accordance with a type of a communication network used in the at least one network service, a communication interface to be used in the at least one network service from among the plural communication interfaces.

### BRIEF DESCRIPTION OF THE DRAWINGS

An exemplary embodiment of the present invention will be described in detail based on the following figures, wherein:

FIG. 1 is a diagram illustrating an example of the configuration of apparatuses in a network service providing system;

FIG. 2 is a functional block diagram illustrating an example of the functional configuration of an image forming apparatus;

FIG. 3 is a diagram illustrating an example of interface information;

FIG. 4 is a diagram illustrating an example of service information;

FIG. 5 is a flowchart illustrating an example of overall processing executed by the image forming apparatus;

FIG. 6 is a flowchart illustrating an example of the overall processing executed by the image forming apparatus;

FIG. 7 is a flowchart illustrating an example of type-of-network determination processing; and

FIG. 8 is a flowchart illustrating an example of communication interface setting processing.

### DETAILED DESCRIPTION

Hereinafter, an exemplary embodiment of the present invention will be described with reference to the drawings. In the individual figures attached to this specification, the same elements as those illustrated in a figure that has already been described are denoted by the same reference numerals, and the detailed description thereof may be omitted.

### 1. System Configuration

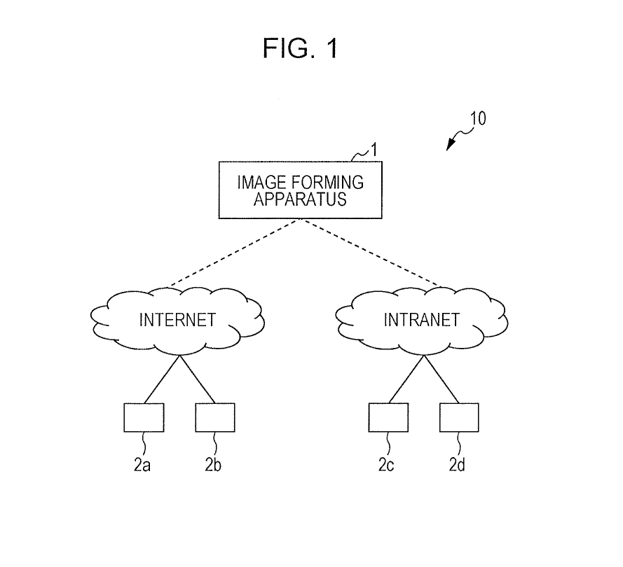

FIG. 1 is a diagram illustrating an example of the configuration of apparatuses in a network service providing system according to the exemplary embodiment. As illustrated in FIG. 1, a network service providing system 10 includes an image forming apparatus 1 and information processing apparatuses 2a to 2d as communication partners (hereinafter each referred to as an information processing apparatus 2 as a communication partner, or simply as a communication partner), which are used in various network services provided in the image forming apparatus 1. Here, a network service is implemented through communication performed with the information processing apparatus 2 as a communication partner, for example, a service in which image data obtained by the image forming apparatus 1 is stored in the information processing apparatus 2 as a communication partner or is distributed by email via the information processing apparatus 2.

The image forming apparatus 1 is, for example, a so-called multifunction peripheral having a facsimile function, a scanner function, and so forth, and includes a controller 11 such as a microprocessor, a memory 12 including a random access memory (RAM) and a hard disk drive, plural communication interfaces 13, an input unit 14 including a mouse, keyboard, and touch panel that accept input from a user, and a display unit 15 such as a display. Here, the memory 12 of the image forming apparatus 1 stores a program for selecting a communication interface 13 that is to be used for communication with a specific communication partner. The controller 11 of the image forming apparatus 1 executes various information processing operations for selecting the communication interface 13 in accordance with the program stored in the memory 12. The program may be supplied to the image forming apparatus 1 via an information storage medium such as a flash memory, or via a communication network such as the Internet.

The plural communication interfaces 13 included in the image forming apparatus 1 are connected to different communication networks. Each of the communication interfaces 13 is connected to the Internet and/or a local area network (hereinafter also referred to as an intranet), as illustrated in FIG. 1. The image forming apparatus 1 may include a communication interface 13 that is not connected to either of the Internet and the intranet.

Each of the information processing apparatuses 2 as a communication partner that communicates with the image forming apparatus 1 is, for example, a server, a personal computer, a mobile phone such as a smartphone, or a tablet terminal. The information processing apparatus 2 includes a controller, a memory, a communication unit, and so forth, like the image forming apparatus 1. The controller of the information processing apparatus 2 executes processing for communicating with the image forming apparatus 1 in accordance with the program stored in the memory of the information processing apparatus 2 or a network service provided in the image forming apparatus 1.

Each of the information processing apparatuses 2 as a communication partner is connected to the image forming apparatus 1 via any one of plural communication networks. In the exemplary embodiment, each communication partner is connected to either of the Internet and the intranet, as illustrated in FIG. 1.

The image forming apparatus 1 according to the exemplary embodiment selects a communication interface 13 capable of communicating with a communication partner that is used in one of various network services. Hereinafter, a detailed description will be given of the function of the image forming apparatus 1 for selecting the communication interface 13.

### 2. Functional Blocks

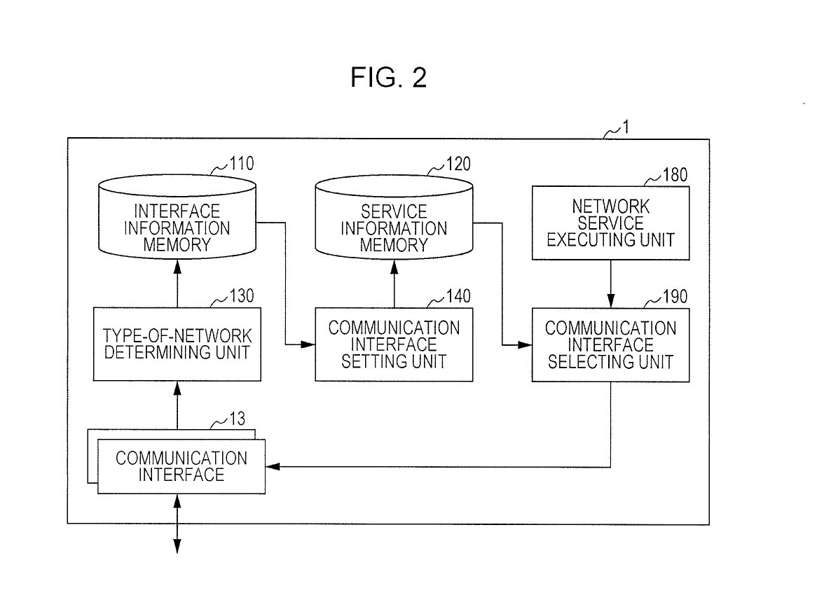

FIG. 2 is a functional block diagram illustrating an example of the functional configuration of the image forming apparatus 1. As illustrated in FIG. 2, the image forming apparatus 1 functionally includes an interface information memory 110, a service information memory 120, a type-of-network determining unit 130, a communication interface setting unit 140, a network service executing unit 180, and a communication interface selecting unit 190. These functions are implemented when the controller 11 of the image forming apparatus 1 executes a program stored in the memory 12 of the image forming apparatus 1.

### 2-1. Interface Information Memory

The interface information memory 110 stores information about the plural communication interfaces 13 included in the image forming apparatus 1 (hereinafter also referred to as interface information). The interface information memory 110 may include the memory 12 of the image forming apparatus 1.

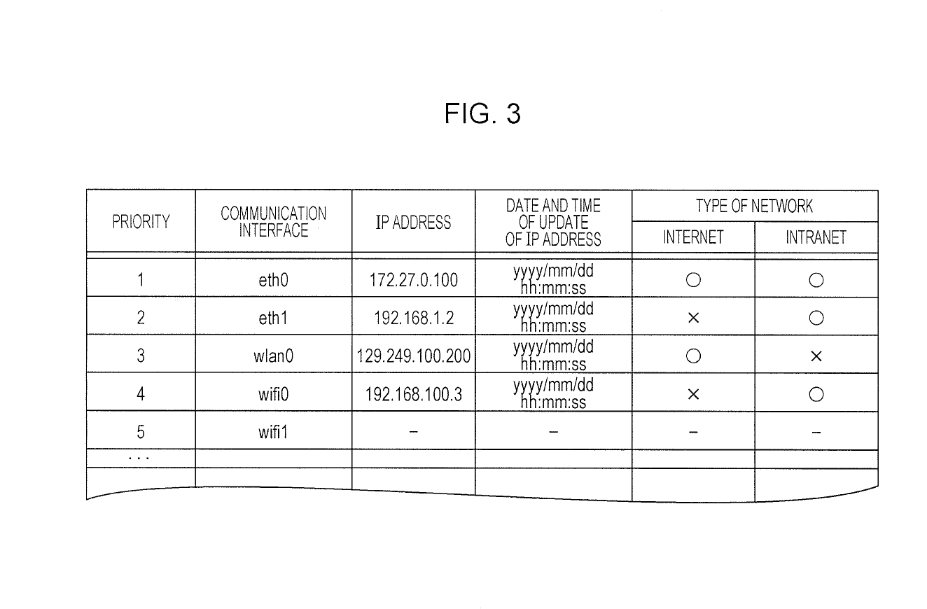

FIG. 3 is a diagram illustrating an example of the interface information stored in the interface information memory 110. As illustrated in FIG. 3, the interface information includes information representing the priorities set for the individual communication interfaces 13, the names of the individual communication interfaces 13, the IP addresses of the individual communication interfaces 13, the dates and times of update of the IP addresses, and the types of communication networks connected to the individual communication interfaces 13 (hereinafter also referred to as types of networks). The type of network is determined by the type-of-network determining unit 130 (described below) and is recorded as the interface information.

### 2-2. Service Information Memory

The service information memory 120 stores information about at least one network service provided in the image forming apparatus 1 (hereinafter also referred to as service information). The service information memory 120 may include the memory 12 of the image forming apparatus 1.

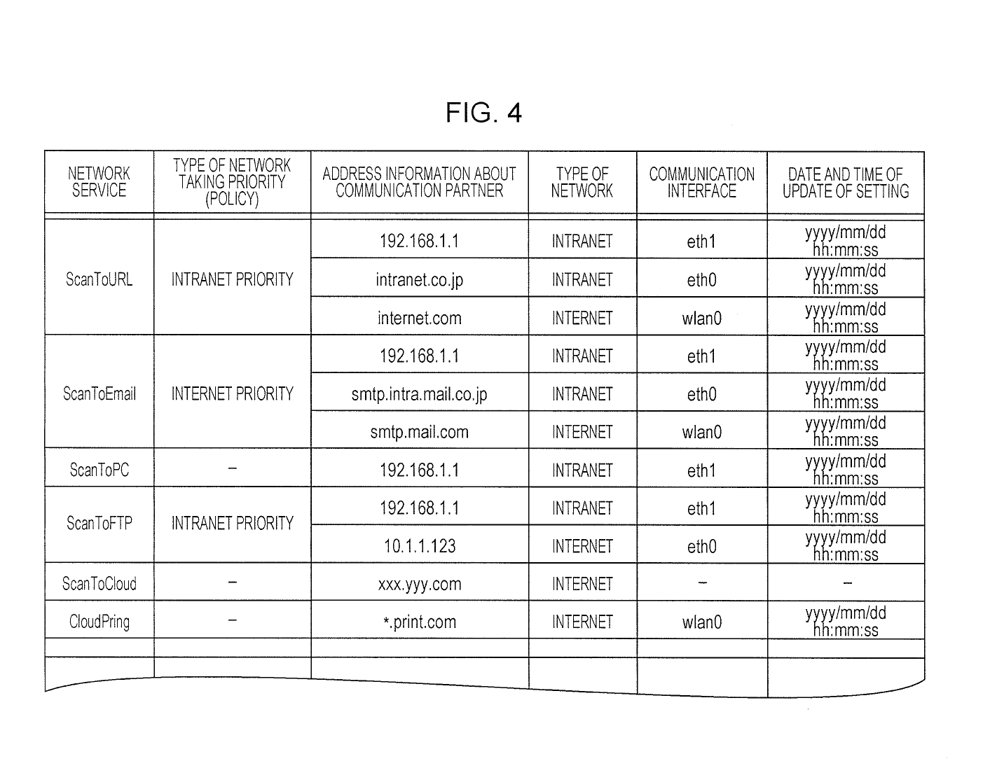

FIG. 4 is a diagram illustrating an example of the service information stored in the service information memory 120. As illustrated in FIG. 4, the service information includes information representing the names of network services, the types of networks taking priority (hereinafter also referred to as policy information), address information about communication partners used in network services, the types of communication networks set for communication partners, the communication interfaces 13 capable of communicating with the communication partners, and the dates and times of update of setting. Here, the information representing the communication interfaces 13 and the dates and times of update of setting is recorded by the communication interface setting unit 140 (described below).

### 2-3. Type-of-Network Determining Unit

The type-of-network determining unit 130 determines the types of communication networks respectively connected to the plural communication interfaces 13 included in the image forming apparatus 1. The type-of-network determining unit 130 determines that, for each of the communication interfaces 13, the type of the communication network connected to the communication interface 13 is the Internet, an intranet, or both of them, and records a result of the determination in “type of network” in the interface information (see FIG. 3).

More specifically, the type-of-network determining unit 130 determines the type of a communication network in accordance with a result of a connection test performed for a communication partner that is predetermined for the type of the communication network. The type-of-network determining unit 130 performs a connection test (for example, a connection test using ping) to determine whether or not the communication interface 13 is capable of connecting to a specific communication partner over the Internet. In a case where the connection test is a success, the type-of-network determining unit 130 determines that the type of the communication network connected to the communication interface 13 is the Internet. Also, the type-of-network determining unit 130 performs a connection test to determine whether or not the communication interface 13 is capable of connecting to a specific communication partner over the intranet. In a case where the connection test is a success, the type-of-network determining unit 130 determines that the type of the communication network is the intranet.

In a case where an IP address is assigned to the communication interface 13 or in a case where the IP address is updated, the type-of-network determining unit 130 determines the type of the communication network connected to the communication interface 13. Here, an IP address is assigned by a dynamic host configuration protocol (DHCP) server (not illustrated) that is connected via a communication network (specifically, the Internet or an intranet), and is updated by the DHCP server when it expires. The type-of-network determining unit 130 may determine that the type of the communication network is the Internet or an intranet at the time when an IP address is assigned to the communication interface 13.

The type-of-network determining unit 130 may determine, in a case where the IP address assigned to the communication interface 13 satisfies a predetermined condition, that the type of the communication network connected to the communication interface 13 is a first type (for example, an intranet), and may determine, in a case where the IP address does not satisfy the predetermined condition, that the type of the communication network is a second type (for example, the Internet). Here, the predetermined condition may be whether the assigned IP address is within the range of a predetermined threshold (for example, from 192.168.0.1 to 192.168.254.254 ) or whether a network portion of the IP address matches a predetermined value.

In a case where an IP address is not assigned to the communication interface 13, the type-of-network determining unit 130 may determine that the communication interface 13 is not connected to either of the Internet and the intranet.

### 2-4. Communication Interface Setting Unit

The communication interface setting unit 140 sets, in accordance with the type of a communication network that is set for a communication partner used in a network service, the communication interface 13 capable of communicating with the communication partner. The communication interface setting unit 140 records, for example, the communication interface 13 connected to the communication network of the communication partner as the communication interface 13 in the service information (see FIG. 4).

More specifically, the communication interface setting unit 140 sets, for the communication partner for which the type of network is the Internet, the communication interface 13 that has been determined to be connected to the Internet, and sets, for the communication partner for which the type of network is the intranet, the communication interface 13 that has been determined to be connected to the intranet.

The communication interface setting unit 140 further sets, in accordance with a result of a communication test that is predetermined for a network service and a communication partner, the communication interface 13 that is to be used by the communication partner. Here, a communication test is a test that is performed to determine whether or not communication with a communication partner is actually able to be performed in accordance with a procedure and a communication protocol that are predetermined for a network service.

For example, in a case where a network service is “ScanToEmail”, the communication interface setting unit 140 performs a communication test for a communication partner in accordance with an SMTP protocol. Specifically, the communication interface setting unit 140 transmits an HELO command, an EHLO command, or the like to the communication partner via the communication interface 13. In a case where a response is received from the communication partner, the communication interface setting unit 140 determines that the communication test is a success, and sets, for the communication partner of the network service “ScanToEmail”, the communication interface 13 that has been used for transmitting the command.

In a case where the type of network in the interface information (see FIG. 3) is updated, the communication interface setting unit 140 sets the communication interfaces 13 to the service information (see FIG. 4). That is, the communication interfaces 13 in the service information are set in a case where an IP address is assigned to any of the communication interfaces 13 or in a case where the IP address is updated.

The communication interface setting unit 140 according to the exemplary embodiment sets the communication interfaces 13 to the service information and records the dates and times of update of the setting. In a case where the communication interface 13 corresponding to the type of network does not exist, or in a case where the communication interface 13 that has succeeded in a communication test does not exist, the communication interface setting unit 140 abandons the setting of the communication interfaces 13 in the service information, and records only the dates and times of update of the setting.

### 2-5. Network Service Executing Unit

The network service executing unit 180 executes at least one network service that is provided in the image forming apparatus 1. The network service executing unit 180 executes, for example, a network service selected by a user via the input unit 14 of the image forming apparatus 1 among the network services recorded in the service information (see FIG. 4).

### 2-6. Communication Interface Selecting Unit

The communication interface selecting unit 190 selects the communication interface 13 that is set, in the service information (see FIG. 4), for the communication partner in a network service executed by the network service executing unit 180. The communication interface 13 is selected as the communication interface 13 that is to be used in the network service. In other words, the communication interface selecting unit 190 selects the communication interface 13 connected to a communication network of a type that is predetermined for the network service. That is, the communication interface selecting unit 190 selects, in accordance with the type of a communication network used in a network service, the communication interface 13 to be used in the network service.

The communication interface selecting unit 190 selects, further in accordance with a result of a communication test that is predetermined for a network service, the communication interface 13 to be used in the network service. For example, in a case where the network service executed by the network service executing unit 180 is a network service related to mail distribution (specifically, “ScanToEmail”), the communication interface selecting unit 190 selects the communication interface 13 connected to a communication network of a type that is predetermined for a communication partner, such as a mail server, that has succeeded in a communication test.

In a case where plural communication partners exist in a network service, the communication interface selecting unit 190 selects any of the communication interfaces 13 set for the communication partners as the communication interface 13 to be used in the network service.

In this case, the communication interface selecting unit 190 selects the communication interface 13 to be used in the network service further in accordance with priorities, for individual types of communication networks, that are predetermined for the network service (policy information). More specifically, the communication interface selecting unit 190 causes the display unit 15 of the image forming apparatus 1 to display information about individual communication partners such that the information is sorted in accordance with the policy information set for the network service in the service information (see FIG. 4). Further, the communication interface selecting unit 190 selects the communication interface 13 that is set for a communication partner selected by the user from among the displayed communication partners, as the communication interface 13 to be used in the network service.

For example, in a case where policy information set for a network service represents “Internet priority”, the communication interface selecting unit 190 causes the display unit 15 to display communication partners by sorting them such that the types of network thereof are displayed in the order of the Internet and intranet, and accepts selection performed by the user. In this case, the communication partner for which the type of network is the intranet is not necessarily displayed.

In a case where plural communication partners exist in a network service and in a case where policy information is not set for the network service, the communication interface selecting unit 190 selects the communication interface 13 to be used in the network service further in accordance with priorities that are predetermined for the communication interfaces 13. The communication interface selecting unit 190 selects, for example, the communication interface 13 of the highest priority from among the communication interfaces 13 set for the plural communication partners.

In this way, the communication interface selecting unit 190 selects the communication interface 13 capable of communicating with a communication partner that is to be used in a network service.

### 3. Flowcharts

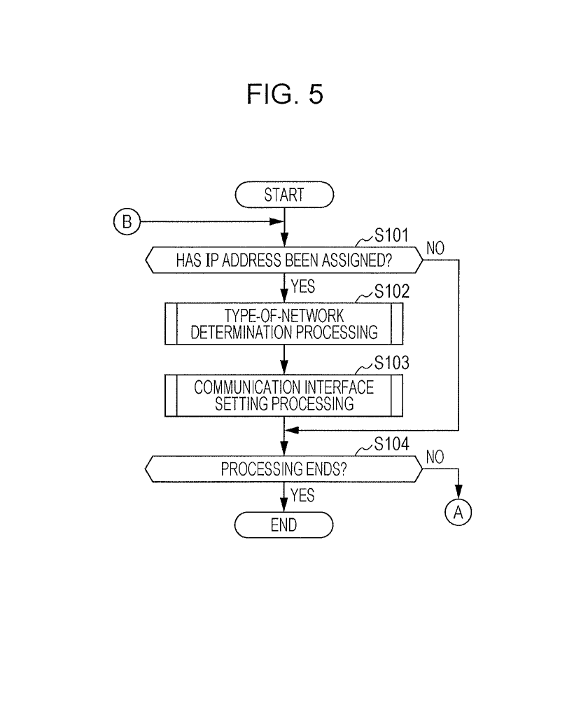

Hereinafter, an example of processing executed by the image forming apparatus 1 according to the exemplary embodiment will be described with reference to the flowcharts illustrated in FIGS. 5 to 8.

### 3-1. Overall Processing, at the Time of Setting Communication Interface (1)

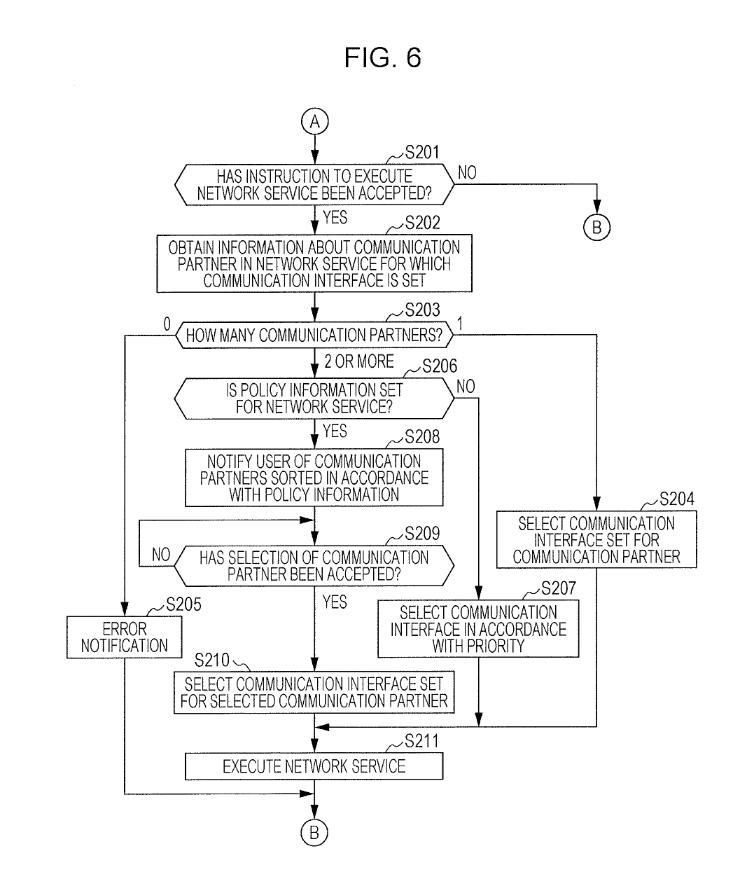

FIGS. 5 and 6 are flowcharts illustrating an example of overall processing executed by the image forming apparatus 1. In particular, FIG. 5 illustrates an example of processing for setting a communication interface 13 for a communication partner in each network service.

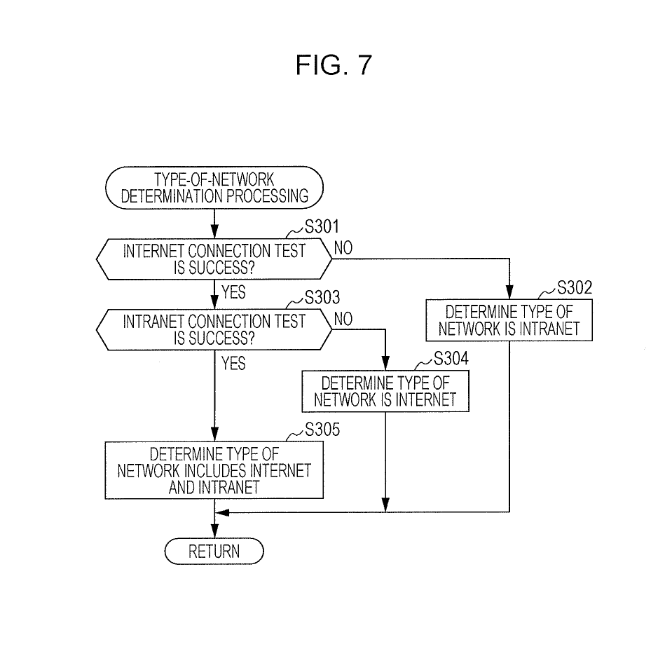

As illustrated in FIG. 5, in a case where an IP address is assigned by a DHCP server to any of the plural communication interfaces 13 included in the image forming apparatus 1, or in a case where the IP address is updated (YES in step S101), the type-of-network determining unit 130 executes type-of-network determination processing (step S102). Hereinafter, the details of the processing executed in step S102 will be described with reference to the flowchart in FIG. 7.

### 3-2. Type-of-Network Determination Processing

FIG. 7 is a flowchart illustrating an example of the type-of-network determination processing. As illustrated in FIG. 7, the type-of-network determining unit 130 executes, for the communication interface 13, a connection test for a specific communication partner connected to the Internet (Internet connection test) in step S301. If the Internet connection test is a failure (NO in step S301), it is considered that the IP address of the communication interface 13 has been assigned by a DHCP server connected to an intranet, and thus the type-of-network determining unit 130 determines in step S302 that the type of the network connected to the communication interface 13 is an intranet, updates the type of network and the date and time of update of the IP address in the interface information (see FIG. 3), and ends the type-of-network determination processing.

If the Internet connection test is a success (YES in step S301), it is considered that the IP address has been assigned by a DHCP server connected to the Internet or an intranet. Thus, at this time, it is not clear whether or not the communication interface 13 is connectable to the intranet. Thus, the type-of-network determining unit 130 performs, for the communication interface 13, a connection test for a specific communication partner connected to the intranet (intranet connection test) in step S303. If the intranet connection test is a failure (NO in step S303), the type-of-network determining unit 130 determines in step S304 that the type of the network connected to the communication interface 13 is the Internet. If the intranet connection test is a success (YES in step S303), the type-of-network determining unit 130 determines in step S305 that the type of the network connected to the communication interface 13 includes the Internet and intranet. Also, the type-of-network determining unit 130 updates the type of network and the date and time of update of the IP address in the interface information (see FIG. 3) and ends the type-of-network determination processing. Hereinafter, a description will be further given referring back to the flowchart in FIG. 5.

### 3-3. Overall Processing, at the Time of Setting Communication Interface (2)

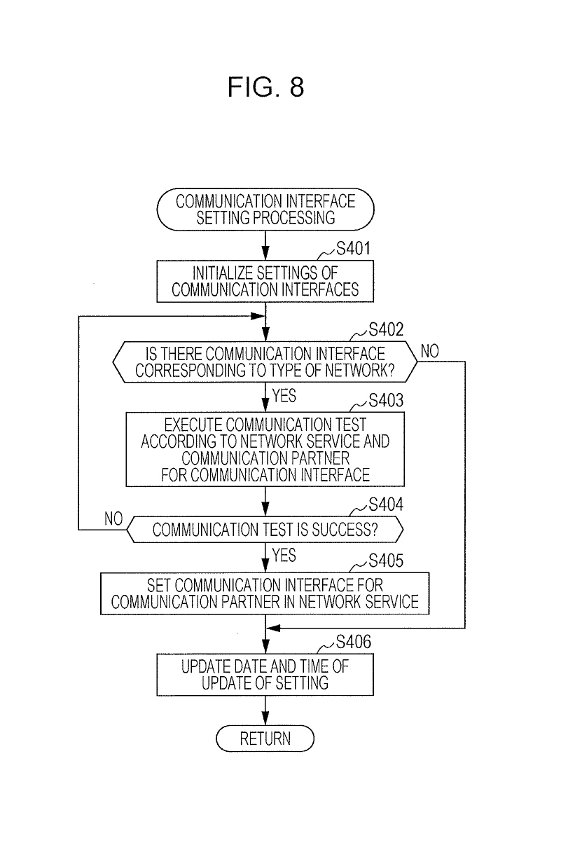

Referring back to FIG. 5, the communication interface setting unit 140 executes communication interface setting processing in step S103. Hereinafter, the details of the processing executed in step S103 will be described with reference to the flowchart illustrated in FIG. 8.

### 3-4. Communication Interface Setting Processing

FIG. 8 is a flowchart illustrating an example of the communication interface setting processing. As illustrated in FIG. 8, the communication interface setting unit 140 initializes the settings of the communication interfaces 13 for individual network services in the service information (see FIG. 4) in step S401. At this time, the communication interface setting unit 140 may compare the date and time of update of setting in the service information with the latest date and time among the dates and times of update of an IP address in the interface information (see FIG. 3). In a case where the date and time of update of setting is earlier than the latest date and time of update of an IP address, the communication interface setting unit 140 may initialize the setting of the communication interface 13 for the network service related to the date and time of update of setting.

The communication interface setting unit 140 determines, regarding the network service for which the setting is initialized in step S401, whether or not the interface information (see FIG. 3) represents the communication interface 13 connected to the communication network corresponding to the type of network of the communication partner (for example, the Internet or an intranet, or both of them) in step S402. If there is the communication interface 13 connected to the communication network of the communication partner (YES in step S402), the communication interface setting unit 140 executes, for the communication interface 13, a communication test for determining whether or not communication with the communication partner is able to be performed in accordance with a procedure and a communication protocol that are predetermined for the network service in step S403.

If the communication test for the communication interface 13 is a success (YES in step S404), the communication interface setting unit 140 sets, for the communication partner indicated by the service information (see FIG. 4), the communication interface 13 for which the communication test has succeeded in step S405, updates the date and time of update of setting to the current date and time in step S406, and ends the communication interface setting processing.

If the communication test is a failure (NO in step S404), the communication interface setting unit 140 determines in step S402 whether or not there is another communication interface 13 connected to the communication network of the communication partner. If there is not another communication interface 13 connected to the communication network of the communication partner (NO in step S402), the communication interface setting unit 140 updates the date and time of update of setting without setting the communication interface 13 to the communication partner, and ends the communication interface setting processing.

In this way, the communication interfaces 13 capable of communicating with the communication partners in the individual network services are set in the service information (see FIG. 4). Hereinafter, the description will be continued with reference to the flowchart illustrated in FIG. 6.

### 3-5. Overall Processing, at the Time of Executing Network Service

FIG. 6 illustrates an example of processing for selecting a communication interface 13 in accordance with a network service to be executed. As illustrated in FIG. 6, when the image forming apparatus 1 accepts an instruction to execute a network service (YES in step S201), the communication interface selecting unit 190 obtains, regarding the network service specified to be executed, the access destination for which the communication interface 13 is set from the service information (see FIG. 4) in step S202.

If the number of access destinations is one (1 in step S203), the communication interface selecting unit 190 selects the communication interface 13 set for this communication partner as the communication interface 13 to be used in the network service in step S204, and the network service executing unit 180 executes the network service in step S211. In the network service to be executed, the selected communication interface 13 is used for communication with the communication partner.

If the number of access destinations is zero (0 in step S203), the communication interface selecting unit 190 notifies the user of the image forming apparatus 1 of an error (specifically, information indicating that the network service is not available) in step S205.

If the number of access destinations is two or more (2 or more in step S203), the communication interface selecting unit 190 determines in step S206 whether or not the type of communication network taking priority (policy information) has been set for the network service. If the policy information has not been set for the network service (NO in step S206), the communication interface selecting unit 190 selects a communication interface 13 in accordance with the priorities of the individual communication interfaces 13 set in the interface information (see FIG. 3) in step S207, and executes the network service in step S211.

If the policy information has been set for the network service (YES in step S206), the communication interface selecting unit 190 notifies the user of the image forming apparatus 1 of plural communication partners in the network service such that the communication partners are sorted in accordance with the policy information in step S208. The communication interface selecting unit 190 resorts the communication partners in accordance with the priorities of the types of networks indicated by the policy information (specifically, Internet priority or intranet priority) and causes the display unit 15 of the image forming apparatus 1 to display the communication partners.

In step S209, the communication interface selecting unit 190 accepts, from the user, selection from among the communication partners that the user is notified of in step S208. If the selection of a communication partner is accepted (YES in step S209), the communication interface selecting unit 190 selects the communication interface 13 set for the selected communication partner as the communication interface 13 that is to be used in the network service in step S210, and executes the network service in step S211.

In this way, in the image forming apparatus 1, in accordance with a network service to be executed, a communication interface 13 capable of communicating with a communication partner that is to be used in this network service is selected.

### 4. Remark

An exemplary embodiment of the present invention has been described above, but the present invention is not limited to the above-described exemplary embodiment. For example, according to the exemplary embodiment, the type-of-network determining unit 130 of the image forming apparatus 1 executes a connection test for a predetermined communication partner, and thereby determines the type of network. Alternatively, the type-of-network determining unit 130 may determine the type of network in accordance with a state of a switch provided in the image forming apparatus 1 (for example, the value or direction indicated by the switch, or an ON/OFF state). The switch may be provided as a member that is actually included in the image forming apparatus 1, or may be provided as software in a virtual manner.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a plurality of communication interfaces;
a network service executing unit that executes at least one network service;
a type-of-network determining unit that determines types of communication networks respectively connected to the plurality of communication interfaces; and
a communication interface selecting unit that selects, in accordance with a type of a communication network used in the at least one network service, a communication interface to be used in the at least one network service from among the plurality of communication interfaces.

2. The image forming apparatus according to claim 1, wherein the communication interface selecting unit selects a communication interface connected to a communication network of a type that is predetermined for the at least one network service from among the plurality of communication interfaces.

3. The image forming apparatus according to claim 1, wherein, in a case where an IP address is assigned to one of the plurality of communication interfaces or in a case where the IP address is updated, the type-of-network determining unit determines a type of a communication network connected to the one communication interface.

4. The image forming apparatus according to claim 1, wherein the type-of-network determining unit determines a type of a communication network in accordance with a result of a connection test performed for a communication partner that is predetermined for the type of the communication network.

5. The image forming apparatus according to claim 4, wherein, in a case where the connection test performed for the communication partner is a success, the type-of-network determining unit determines the type of the communication network corresponding to the communication partner.

6. The image forming apparatus according to claim 1, wherein the type-of-network determining unit determines, in a case where an IP address assigned to one of the plurality of communication interfaces satisfies a predetermined condition, that a type of a communication network connected to the one communication interface is a first type, and determines, in a case where the IP address does not satisfy the predetermined condition, that the type of the communication network is a second type.

7. The image forming apparatus according to claim 1, wherein the communication interface selecting unit selects the communication interface to be used in the at least one network service further in accordance with a result of a communication test that is predetermined for the at least one network service.

8. The image forming apparatus according to claim 7, wherein the at least one network service is related to mail distribution, and the communication interface selecting unit selects, for the at least one network service, a communication interface connected to a network of a type that is predetermined for a mail server that has succeeded in the communication test from among the plurality of communication interfaces.

9. The image forming apparatus according to claim 1, wherein the communication interface selecting unit selects the communication interface to be used in the at least one network service further in accordance with priorities, for individual types of communication networks, that are predetermined for the at least one network service.

10. The image forming apparatus according to claim 1, wherein the communication interface selecting unit selects the communication interface to be used in the at least one network service further in accordance with priorities that are predetermined for the plurality of communication interfaces.

11. A processing method comprising:
executing at least one network service;
determining types of communication networks respectively connected to a plurality of communication interfaces; and
selecting, in accordance with a type of a communication network used in the at least one network service, a communication interface to be used in the at least one network service from among the plurality of communication interfaces.

12. A non-transitory computer readable medium storing a program causing a computer to execute a process, the process comprising:
executing at least one network service;
determining types of communication networks respectively connected to a plurality of communication interfaces; and
selecting, in accordance with a type of a communication network used in the at least one network service, a communication interface to be used in the at least one network service from among the plurality of communication interfaces.
